(19) United States
(12) Patent Application Publication
(10) Pub. No.: US 2013/0044121 A1
(43) Pub. Date: Feb. 21, 2013

(54) ELECTROPHORETIC DISPLAY CAPABLE OF REDUCING GHOST SHADOWS AND FRAME REFRESH METHOD THEREOF

(71) Applicants: De-Wei Kuo, Taipei City (TW); Jhen-Shen Liao, Taoyuan County (TW); Hung-Hsiang Chen, Taoyuan County (TW)

(72) Inventors: De-Wei Kuo, Taipei City (TW); Jhen-Shen Liao, Taoyuan County (TW); Hung-Hsiang Chen, Taoyuan County (TW)

(21) Appl. No.: 13/239,428

(22) Filed: Sep. 22, 2011

(30) Foreign Application Priority Data
Aug. 16, 2011 (TW) 100129253

(51) Int. Cl. G09G 5/02; G09G 3/34

(52) U.S. Cl. 345/589; 345/107

(57) ABSTRACT

An electrophoretic display capable of reducing ghost shadows includes an electrophoretic panel, a pixel gray level recording unit, and a control signal generation unit. The electrophoretic panel includes a plurality of pixels. The pixel gray level recording unit is used for recording gray levels of the plurality of pixels when the electrophoretic panel displays a frame according to an image signal. The control signal generation unit is coupled to the pixel gray level recording unit and the plurality of pixels for providing a first refresh control signal for a first group pixels of the plurality of pixels and a second refresh control signal different from the first refresh control signal for a second group pixels of the plurality of pixels according to the gray levels of the plurality of pixels when the electrophoretic panel refreshes the frame according to the image signal.

### BACKGROUND OF THE INVENTION

1. Field of the Invention

The present invention is related to an electrophoretic display and frame refresh method thereof, and particularly to an electrophoretic display and frame refresh method thereof that can disturb particles of each pixel according to a gray level of the pixel to reduce ghost shadows of the electrophoretic display.

2. Description of the Prior Art

An electrophoretic display has many advantages, such as high portability, low power consumption, zero paper waste, and reduced carbon emissions. An electrophoretic panel of the electrophoretic display utilizes voltages to control black/white charged particles to achieve gray levels corresponding to a displayed frame. The biggest disadvantage of electrophoretic panels is blur (ghost shadows). Blur occurs when the black/white particles do not achieve gray levels corresponding to a new frame when the electrophoretic panel refreshes a frame. That is to say, some black/white particles of the black/white particles remain at gray levels corresponding to a previous frame, so the new frame shows some part of the previous frame. Therefore, the prior art disturbs the black/white particles significantly before the electrophoretic panel refreshes the frame to prevent the black/white particles from staying at the gray levels corresponding to the previous frame.

Please refer to FIG. 1A and FIG. 1B. FIG. 1A and FIG. 1B are diagrams illustrating black/white charged particles moving according to refresh control voltages when an electrophoretic panel 102 refreshes a frame according to the prior art, where the white particles have negative charges and the black particles have positive charges. As shown in FIG. 1A, a common electrode VCOM of the electrophoretic panel 102 first inputs a negative voltage, so the white particles move to a top side of the electrophoretic panel 102, and the black particles move to a bottom side of the electrophoretic panel 102. Thus, the electrophoretic panel 102 shows white color due to the white particles being located at the top side of the electrophoretic panel 102. Then, the common electrode VCOM inputs a positive voltage, so the black particles move to the top side of the electrophoretic panel 102, and the white particles move to the bottom side of the electrophoretic panel 102. Thus, the electrophoretic panel 102 shows black color due to the black particles being located at the top side of the electrophoretic panel 102. As shown in FIG. 1B, the common electrode VCOM first inputs the positive voltage, so the black particles move to the top side of the electrophoretic panel 102, and the white particles move to the bottom side of the electrophoretic panel 102. Thus, the electrophoretic panel 102 shows the black color due to the black particles being located at the top side of the electrophoretic panel 102. Then, the common electrode VCOM inputs the negative voltage, so the white particles move to the top side of the electrophoretic panel 102, and the black particles move to the bottom side of the electrophoretic panel 102. Thus, the electrophoretic panel 102 shows the white color due to the white particles being located at the top side of the electrophoretic panel 102.

FIG. 2 is a timing diagram illustrating the voltages inputted by the common electrode VCOM in FIG. 1B. As shown in FIG. 2, G1 to GN are gray levels, where GN represents the blackest gray level, and N is a positive integer. TBLACK represents time for the common electrode VCOM to provide a positive voltage VPOS, during which time the black particles move to the top side of the electrophoretic panel 102, so that the electrophoretic panel 102 shows the black color. TWHITE represents time for the common electrode VCOM to provide a negative voltage VNEG, during which time the white particles move to the top side of the electrophoretic panel 102, so that the electrophoretic panel 102 shows the white color. TINITIAL represents time for the electrophoretic panel 102 to refresh the frame, and is equal to a sum of TBLACK and TWHITE. In addition, TG1 to TGN represent time for the black/white particles to move to gray levels corresponding to a next frame after the electrophoretic panel 102 refreshes the frame. TWAIT represents time for particles with shorter moving distances to wait for particles with longer moving distances to move to corresponding gray levels, during which time the common electrode VCOM only provides a maintenance voltage VDATA, instead of providing the positive voltage VPOS or the negative voltage VNEG.

Although, the prior art can effectively reduce the blur of the electrophoretic panel 102, the electrophoretic panel 102 first shows the white color and then the black color, or first shows the black color and then the white color during the frame refresh. Therefore, a user may notice strong flicker in the electrophoretic panel 102 as the electrophoretic panel 102 refreshes the frame. In addition, the prior art significantly disturbs the black/white particles, so distances of motion of the black/white particles are longer, which increases time required for the electrophoretic panel 102 to refresh the frame, time for providing voltages, and power consumption.

### SUMMARY OF THE INVENTION

An embodiment provides an electrophoretic display capable of reducing ghost shadows. The electrophoretic display includes an electrophoretic panel, a pixel gray level recording unit, and a control signal generation unit. The electrophoretic panel includes a plurality of pixels. The pixel gray level recording unit is used for recording the gray levels of the plurality of pixels when the electrophoretic panel displays a frame according to an image signal. The control signal generation unit is coupled to the pixel gray level recording unit and the a plurality of pixels for providing a first refresh control signal for a first group pixels of the plurality of pixels and a second refresh control signal different from the first refresh control signal for a second group pixels of the plurality of pixels according to the gray levels of the plurality of pixels when the electrophoretic panel refreshes the frame according to the image signal.

Another embodiment provides a frame refresh method capable of reducing ghost shadows. The frame refresh method includes recording gray levels of a plurality of pixels when an electrophoretic panel displays a frame according to an image signal; providing a first refresh control signal for a first group pixels of the plurality of pixels and a second refresh control signal different from the first refresh control signal for a second group pixels of the plurality of pixels according to the gray levels of the plurality of pixels when the electrophoretic panel refreshes the frame according to the image signal; and providing gray level control signals for the plurality of pixels according to gray levels of the plurality of pixels when the electrophoretic panel displays a new frame according to the image signal, and a lookup table to adjust the gray levels of the plurality of pixels to correspond to the new frame after the electrophoretic panel refreshes the frame.

The present invention provides an electrophoretic display capable of reducing ghost shadows and a frame refresh method thereof. Advantages of the electrophoretic display and the frame refresh method thereof are that particles (a plurality of black particles and a plurality of white particles) of each pixel of the electrophoretic panel are disturbed according to a gray level of each pixel as an electrophoretic panel refreshes a frame. Because paths of motion of particles included by a plurality of pixels of the electrophoretic panel do not all first move upward and then move downward to the bottom of the electrophoretic display, or first move downward and then move upward to the top of the electrophoretic display, the present invention can improve strong flicker of the electrophoretic panel while the electrophoretic panel refreshes the frame. In addition, the present invention can determine paths of motion of particles of each pixel according to a gray level of the pixel, so the present invention can not only reduce distances of motion of particles of the pixel, but also does not provide an additional voltage for a particle with a shorter distances of motion when the particle with the shorter distances of motion to wait for a particle with a longer distances of motion to move to a corresponding gray level. Thus, compared to the prior art, the present invention can reduce time and power consumption for the electrophoretic panel to refresh the frame.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A and FIG. 1B are diagrams illustrating black/white charged particles moving according to refresh control voltages when an electrophoretic panel refreshes a frame according to the prior art.

FIG. 2 is a timing diagram illustrating the voltages inputted by the common electrode in FIG. 1B.

FIG. 3A is a diagram illustrating an electrophoretic display capable of reducing ghost shadows according to a first embodiment.

FIG. 3B is a diagram illustrating a pixel including a plurality of white particles and a plurality of black particles.

FIG. 3C is a diagram illustrating cross-section of the electrophoretic panel.

FIG. 3D is a diagram illustrating a lookup table.

FIG. 3A, FIG. 3C, FIG. 3D, FIG. 4A, FIG. 4B, FIG. 4C, and FIG. 4D are diagrams illustrating the control signal generation unit providing a first refresh control signal for the first group pixels of the plurality of pixels of the electrophoretic panel and a second refresh control signal different from the first refresh control signal for the second group pixels of the plurality of pixels of the electrophoretic panel according to gray levels of the plurality of pixels of the electrophoretic panel when the electrophoretic panel refreshes a frame according to an image signal according to a second embodiment.

FIG. 4E is a diagram illustrating the first refresh control signal and the second refresh control signal corresponding to the second embodiment.

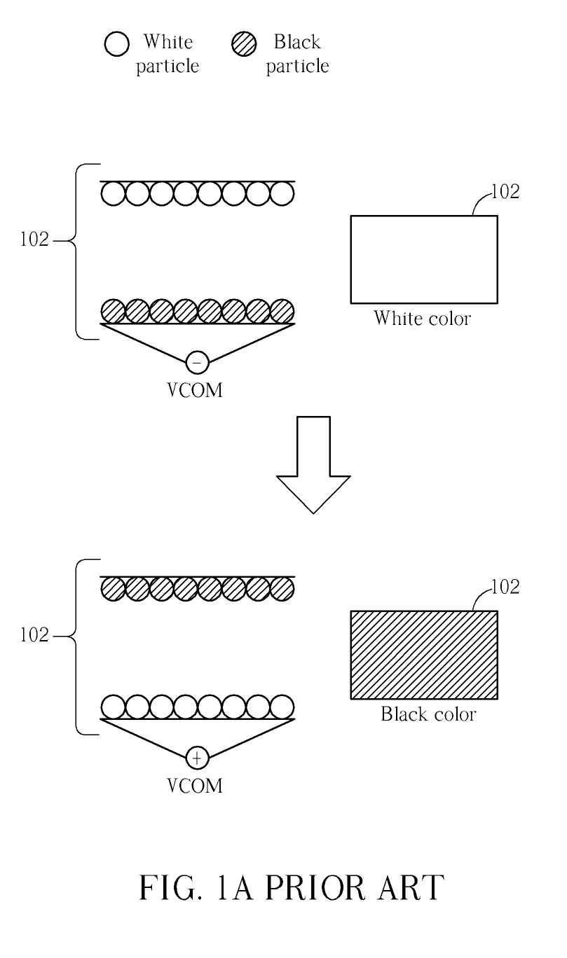

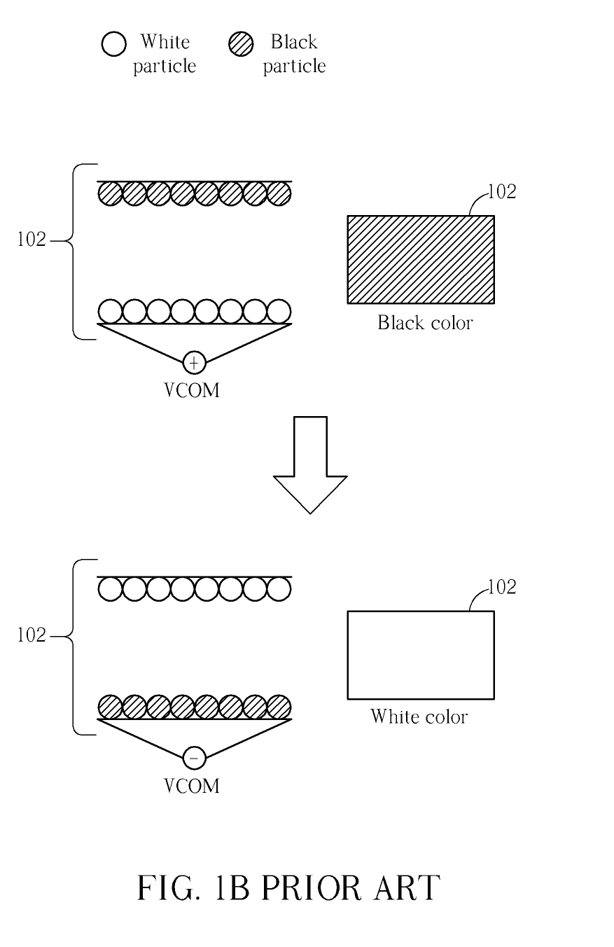

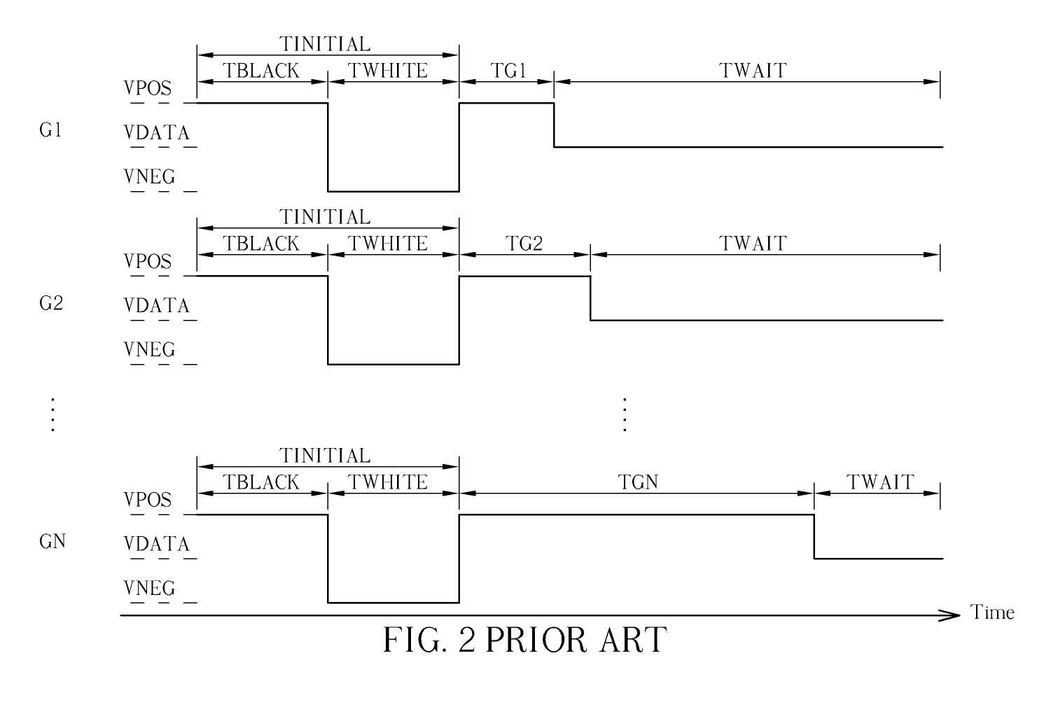

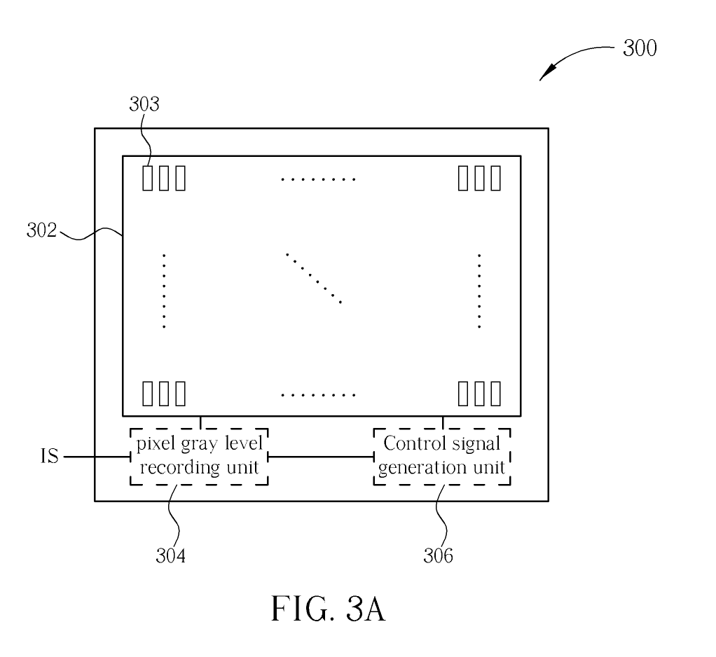

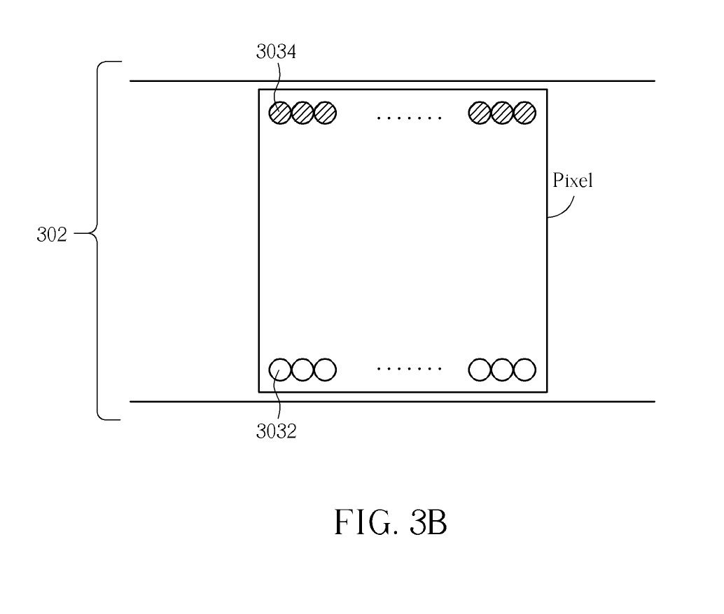

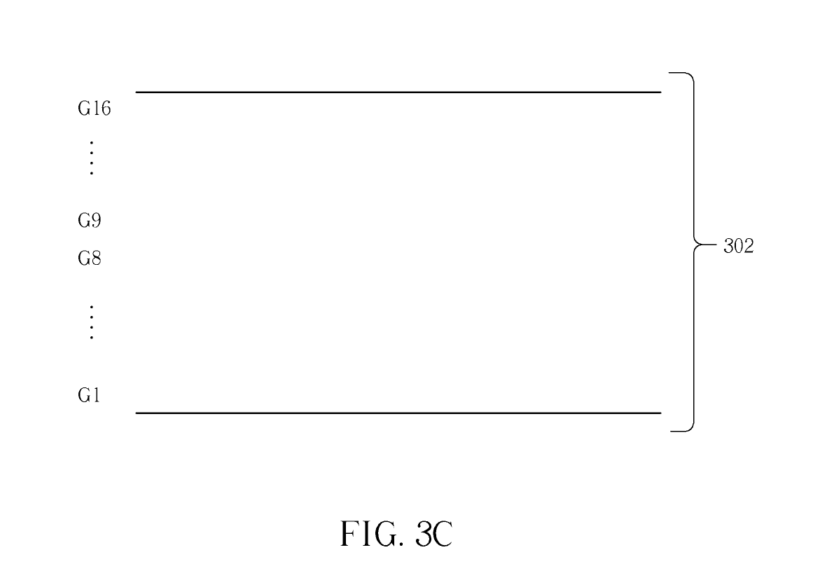

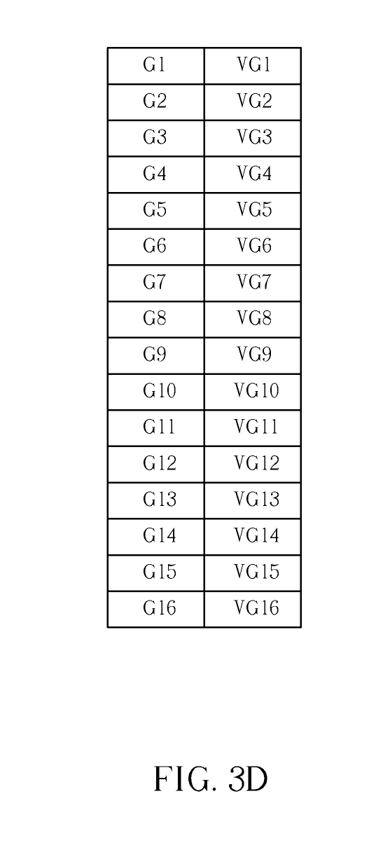

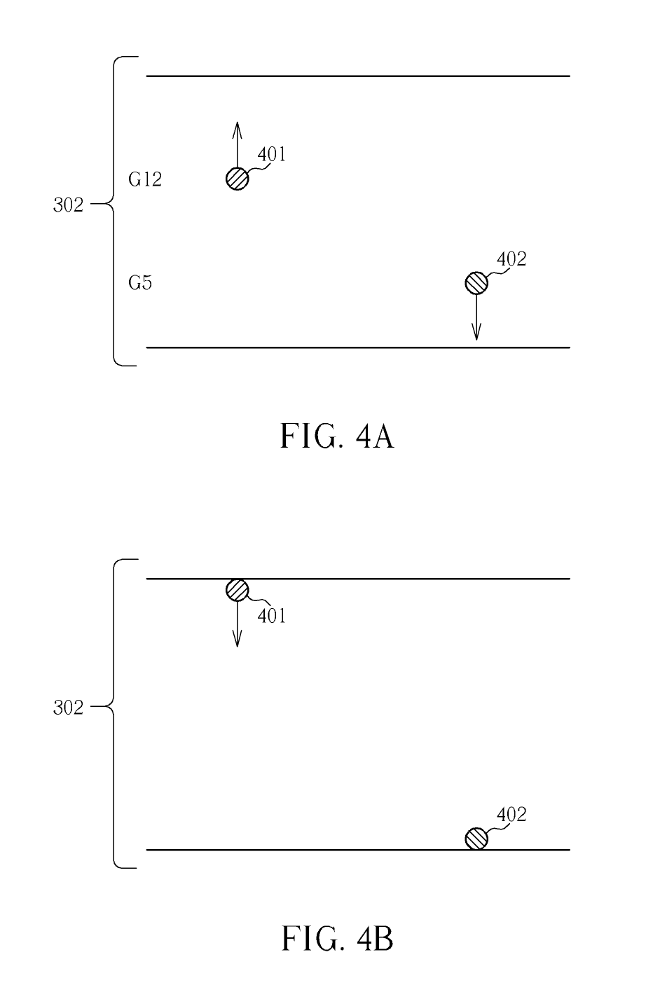

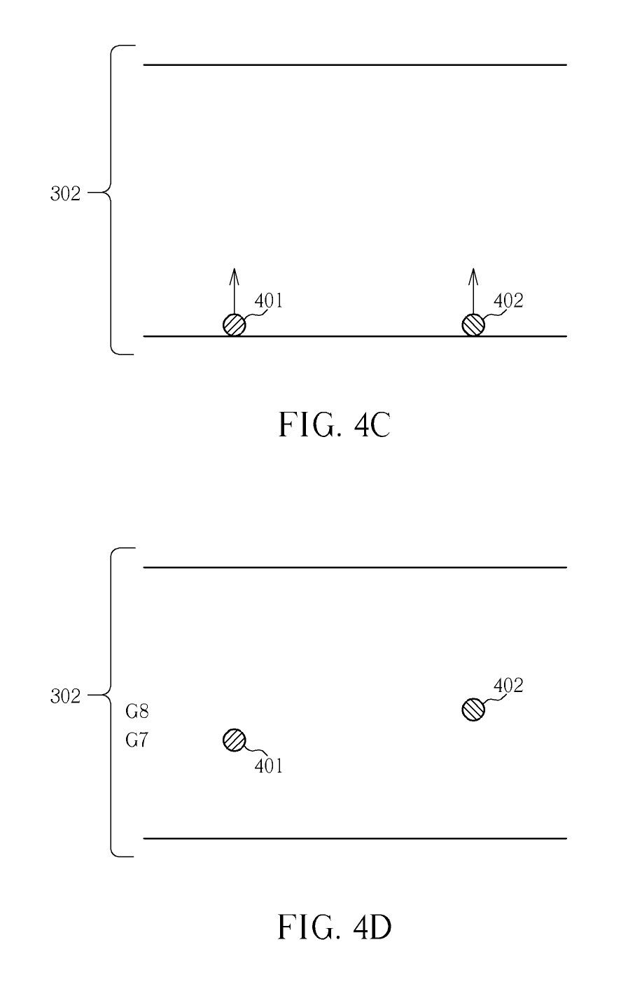

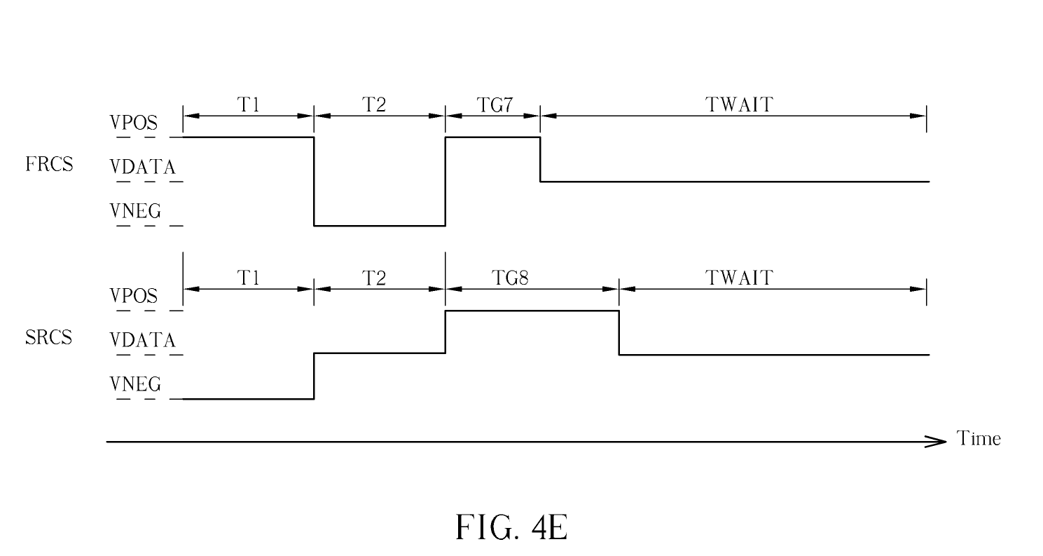

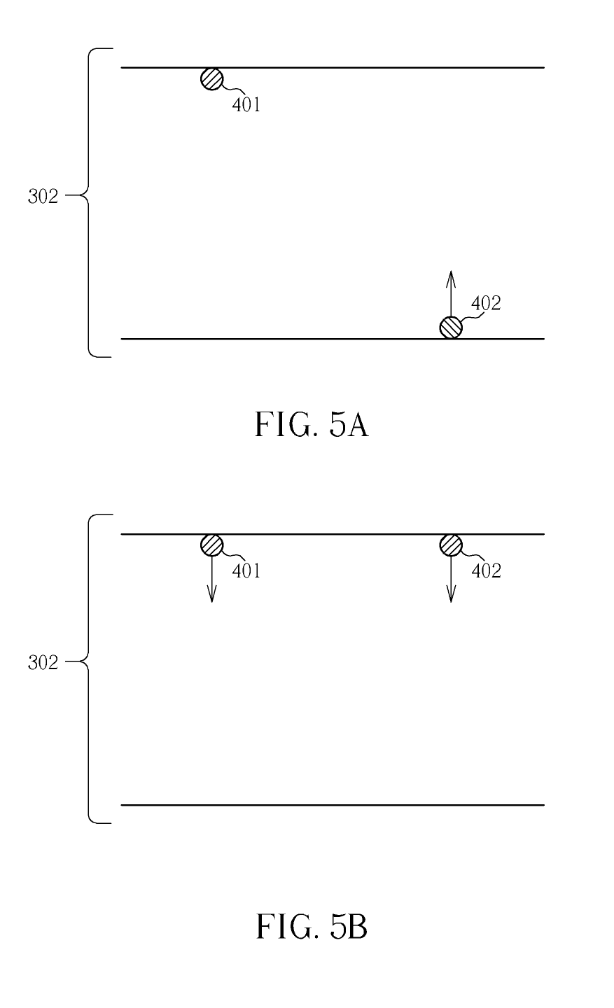

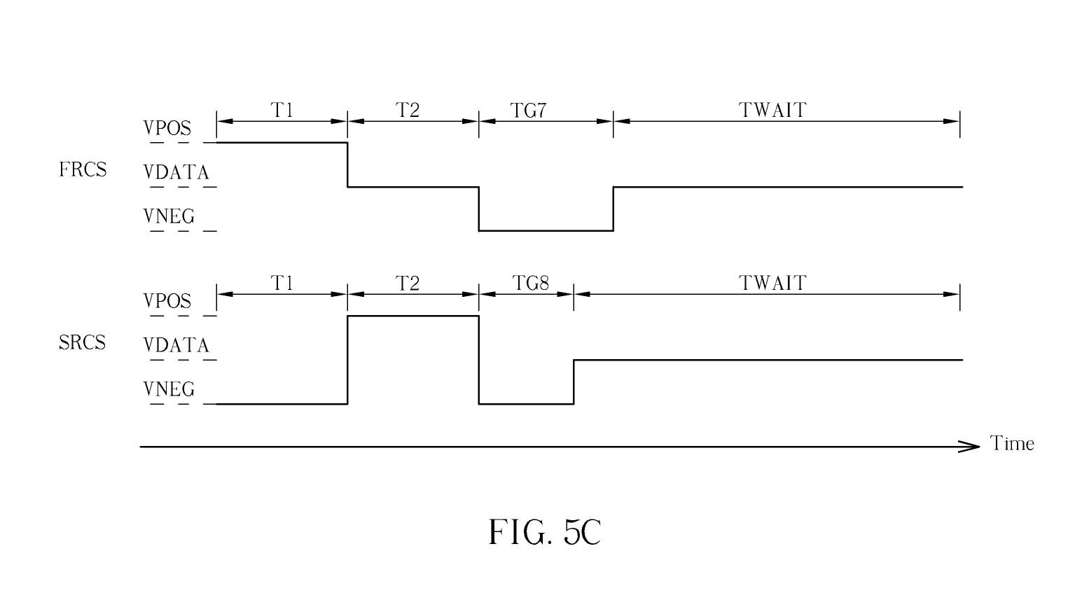

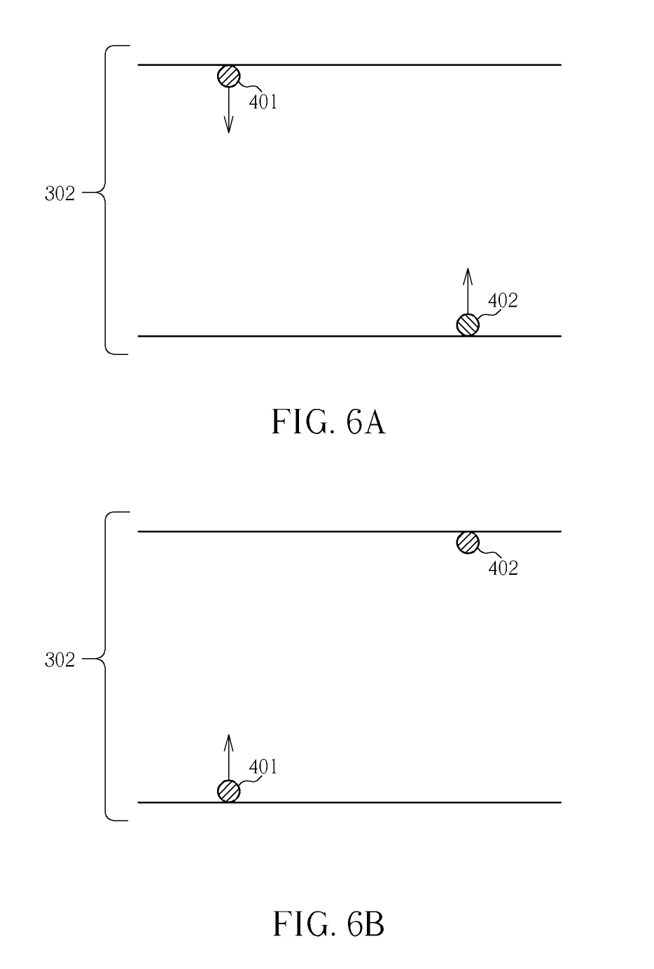

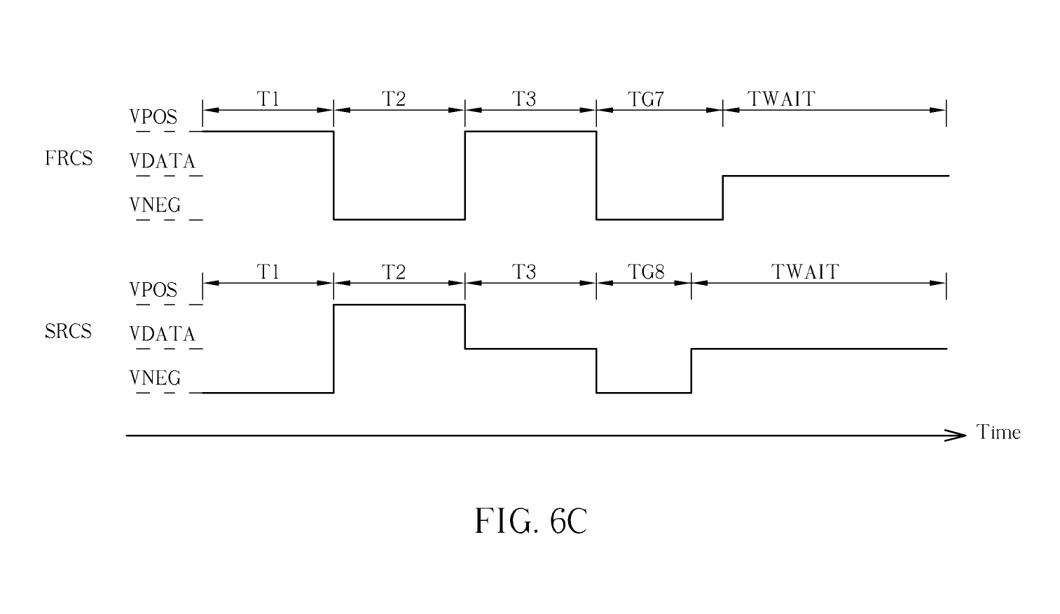

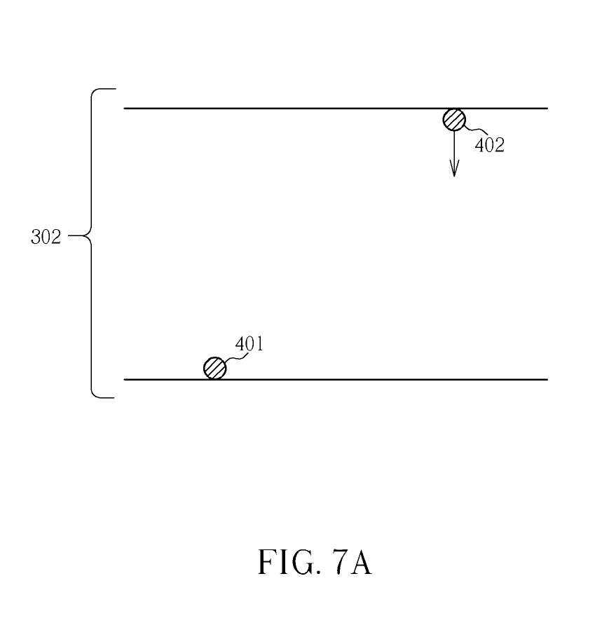

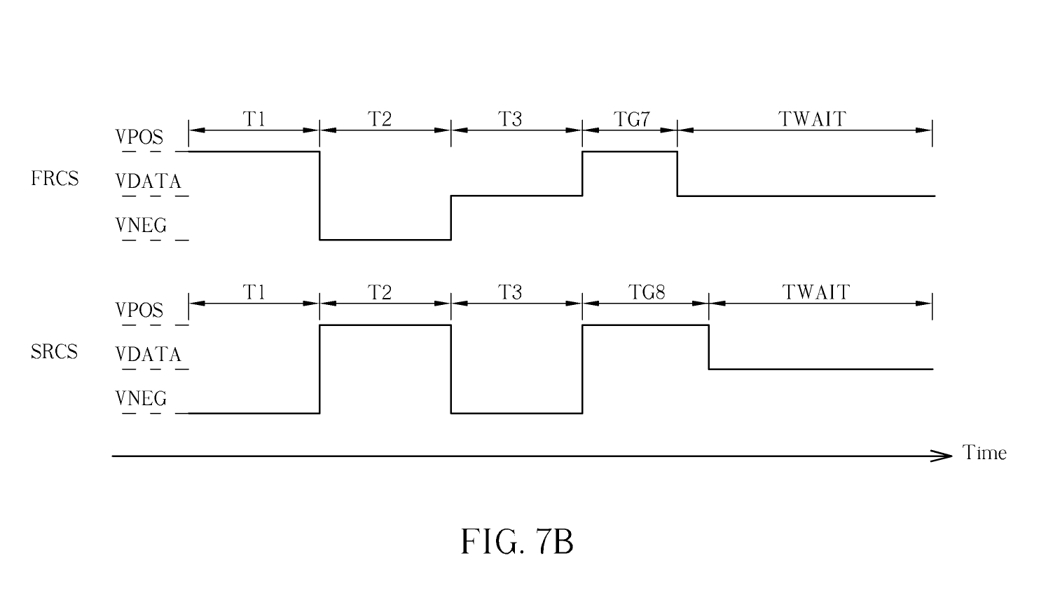

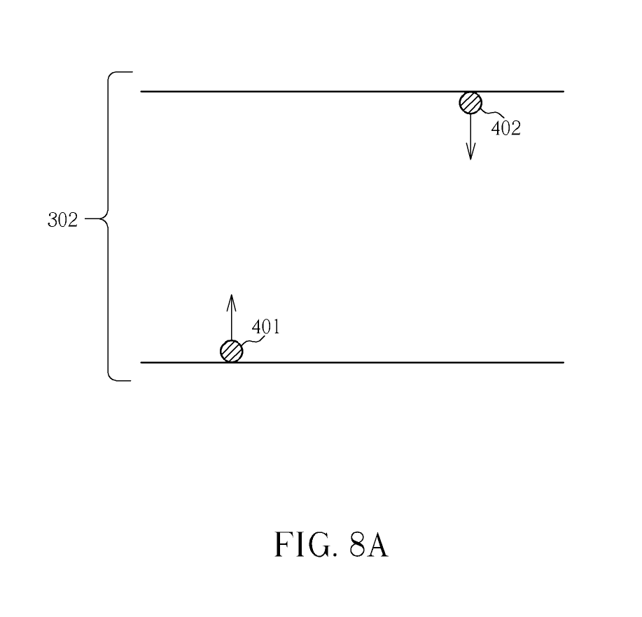

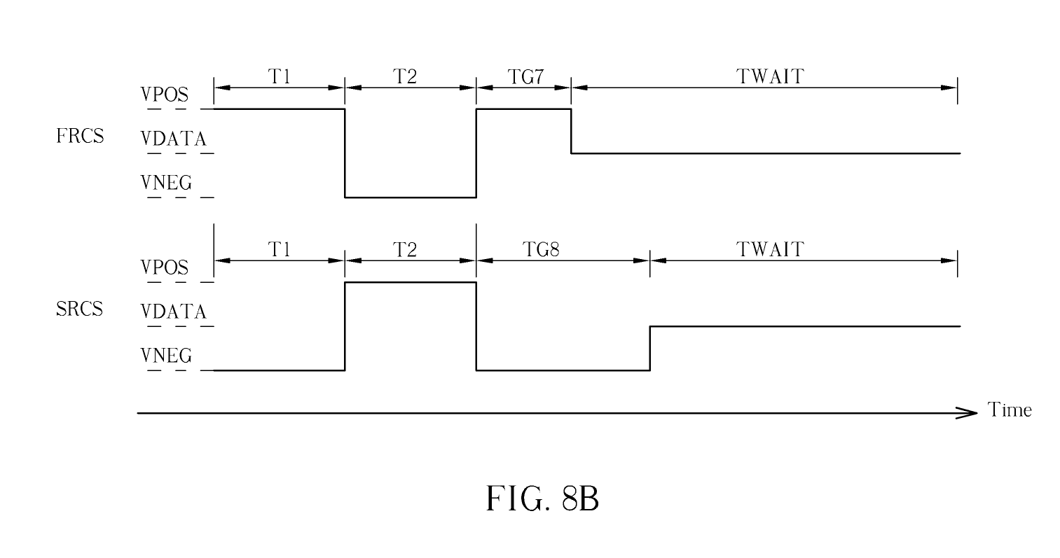

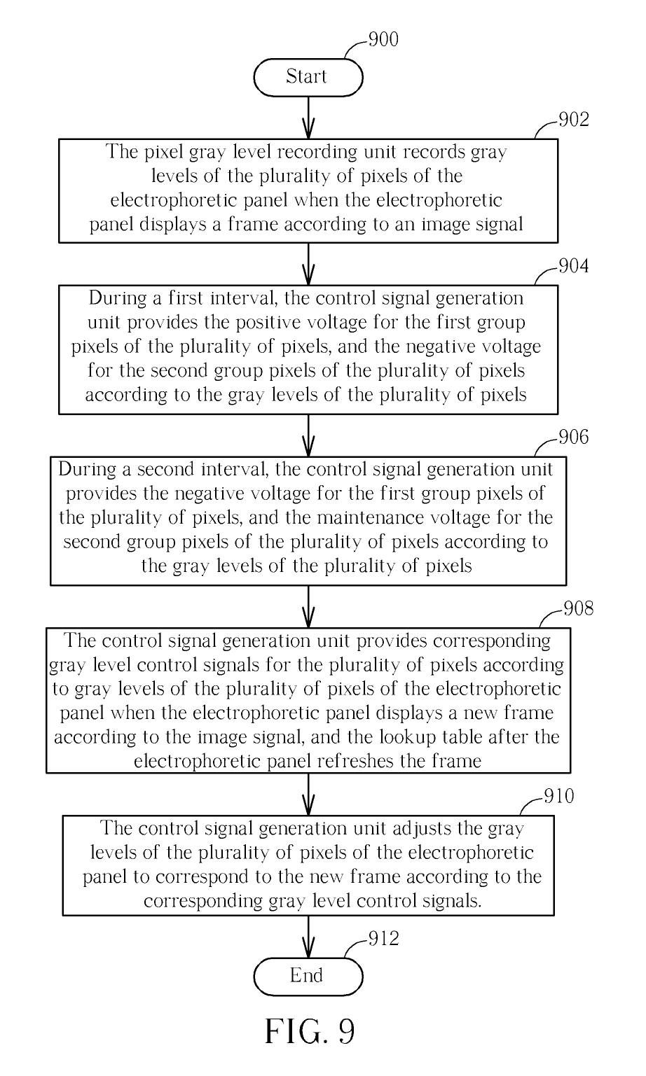

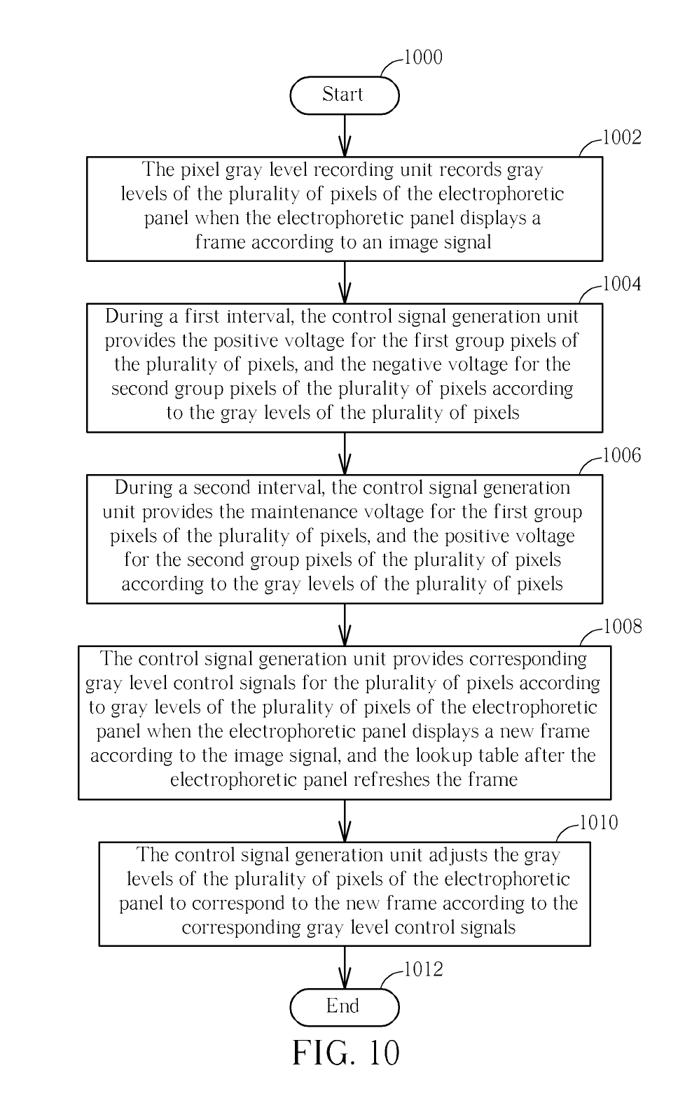

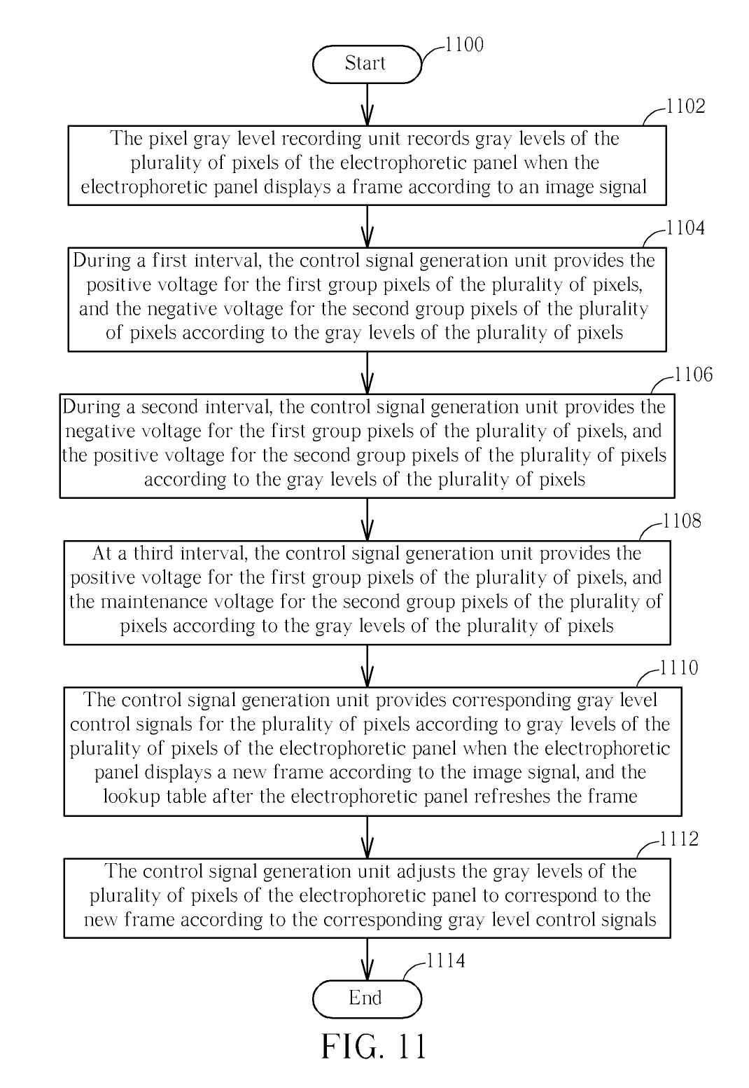

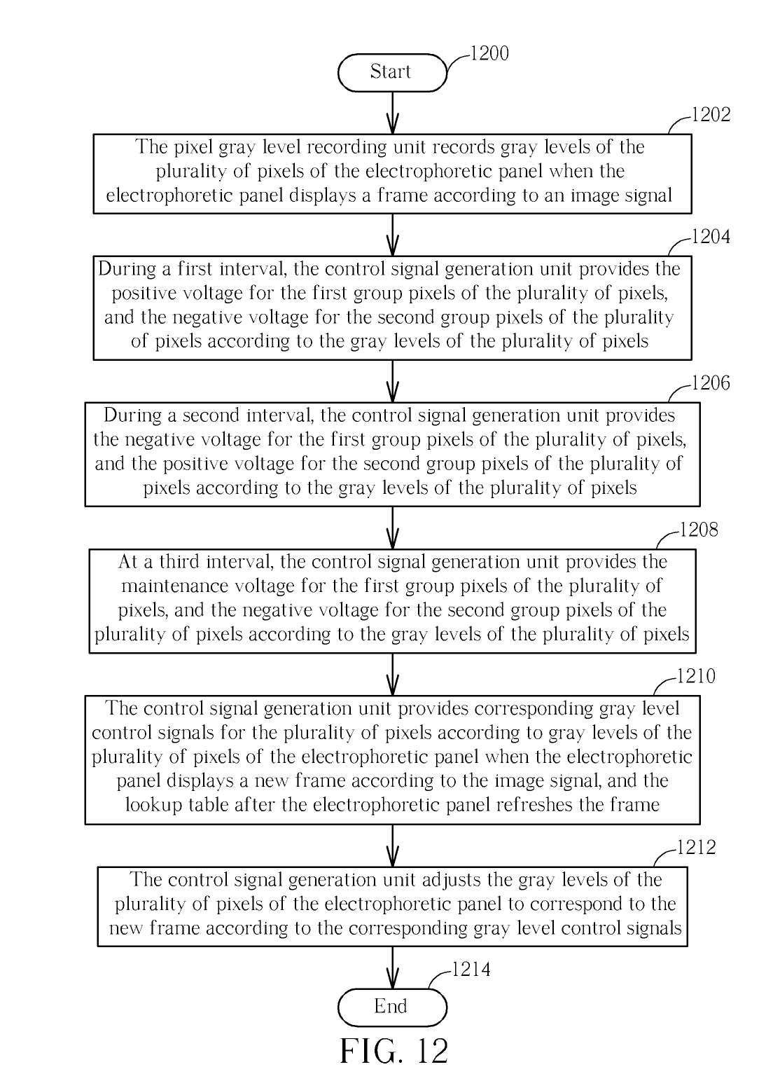

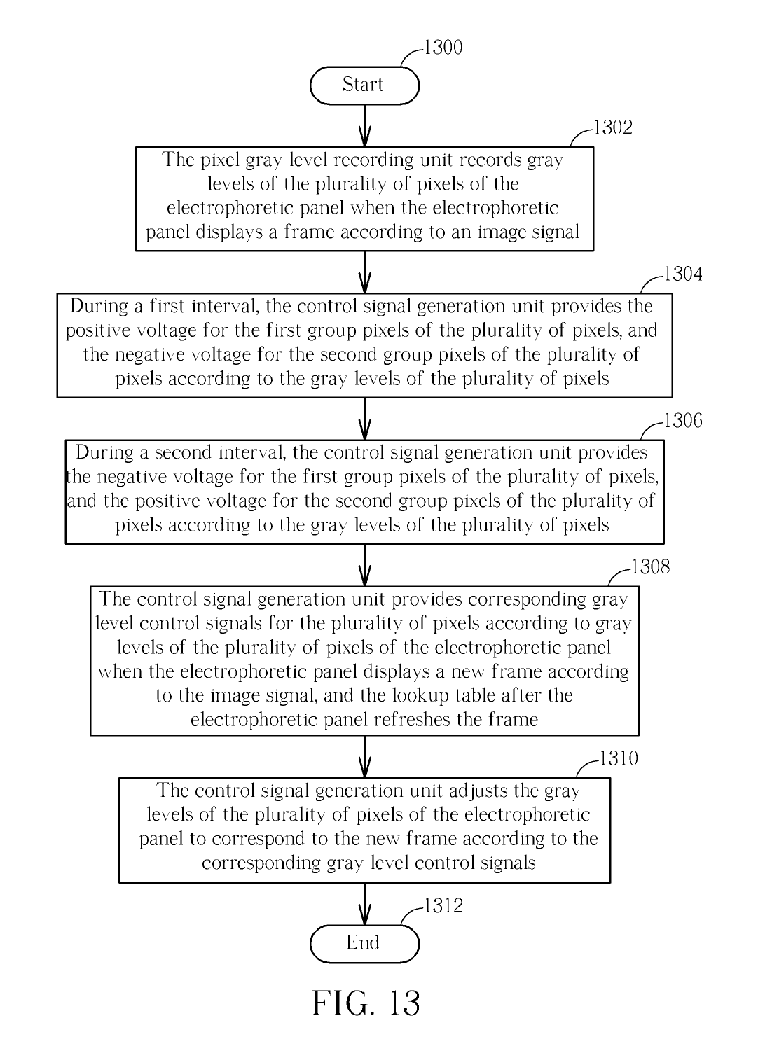

FIG. 3A, FIG. 3C, FIG. 3D, FIG. 4A, FIG. 5A, FIG. 5B, and FIG. 4D are diagrams illustrating the control signal generation unit providing a first refresh control signal for the first group pixels of the plurality of pixels of the electrophoretic panel and a second refresh control signal different from the first refresh control signal for the second group pixels of the plurality of pixels of the electrophoretic panel according to gray levels of the plurality of pixels of the electrophoretic panel when the electrophoretic panel refreshes a frame according to an image signal according to a third embodiment.

FIG. 5C is a diagram illustrating the first refresh control signal and the second refresh control signal corresponding to the third embodiment.

FIG. 3A, FIG. 3C, FIG. 3D, FIG. 4A, FIG. 6A, FIG. 6B, FIG. 5B, FIG. 4D are diagrams illustrating the control signal generation unit providing a first refresh control signal for the first group pixels of the plurality of pixels of the electrophoretic panel and a second refresh control signal different from the first refresh control signal for the second group pixels of the plurality of pixels of the electrophoretic panel according to gray levels of the plurality of pixels of the electrophoretic panel when the electrophoretic panel refreshes a frame according to an image signal according to a fourth embodiment.

FIG. 6C is a diagram illustrating the first refresh control signal and the second refresh control signal corresponding to the fourth embodiment.

FIG. 3A, FIG. 3C, FIG. 3D, FIG. 4A, FIG. 6A, FIG. 7A, FIG. 4C, and FIG. 4D are diagrams illustrating the control signal generation unit providing a first refresh control signal for the first group pixels of the plurality of pixels of the electrophoretic panel and a second refresh control signal different from the first refresh control signal for the second group pixels of the plurality of pixels of the electrophoretic panel according to gray levels of the plurality of pixels of the electrophoretic panel when the electrophoretic panel refreshes a frame according to an image signal according to a fifth embodiment.

FIG. 7B is a diagram illustrating the first refresh control signal and the second refresh control signal corresponding to the fifth embodiment.

FIG. 3A, FIG. 3C, FIG. 3D, FIG. 4A, FIG. 6A, FIG. 8A, and FIG. 4D are diagrams illustrating the control signal generation unit providing a first refresh control signal for the first group pixels of the plurality of pixels of the electrophoretic panel and a second refresh control signal different from the first refresh control signal for the second group pixels of the plurality of pixels of the electrophoretic panel according to gray levels of the plurality of pixels of the electrophoretic panel when the electrophoretic panel refreshes a frame according to an image signal according to a sixth embodiment.

FIG. 8B is a diagram illustrating the first refresh control signal and the second refresh control signal corresponding to the sixth embodiment.

FIG. 9 is a flowchart illustrating a frame refresh method capable of reducing ghost shadows according to a seventh embodiment.

FIG. 10 is a flowchart illustrating a frame refresh method capable of reducing ghost shadows according to an eighth embodiment.

FIG. 11 is a flowchart illustrating a frame refresh method capable of reducing ghost shadows according to a ninth embodiment.

FIG. 12 is a flowchart illustrating a frame refresh method capable of reducing ghost shadows according to a tenth embodiment.

FIG. 13 is a flowchart illustrating a frame refresh method capable of reducing ghost shadows according to an eleventh embodiment.

### DETAILED DESCRIPTION

Please refer to FIG. 3A. FIG. 3A is a diagram illustrating an electrophoretic display 300 capable of reducing ghost shadows according to a first embodiment. The electrophoretic display 300 includes an electrophoretic panel 302, a pixel gray level recording unit 304, and a control signal generation unit 306. As shown in FIG. 3A, the electrophoretic panel 302 includes a plurality of pixels 303, where each of the plurality of pixels 303 includes a plurality of white particles and a plurality of black particles. Please refer to FIG. 3B. FIG. 3B is a diagram illustrating a pixel including a plurality of white particles 3032 and a plurality of black particles 3034. As shown in FIG. 3B, because movement direction of the plurality of white particles 3032 is opposite movement direction of the plurality of black particles 3034 when the control signal generation unit 306 provides the same voltage for the plurality of white particles 3032 and the plurality of black particles 3034, locations of the plurality of white particles 3032 in the pixel are opposite of locations of the plurality of black particles 3034 in the pixel. The pixel gray level recording unit 304 is used for recording gray levels of the plurality of pixels 303 of the electrophoretic panel 302 when the electrophoretic panel 302 displays a frame according to an image signal IS. The control signal generation unit 306 is coupled to the pixel gray level recording unit 304 and the plurality of pixels 303 of the electrophoretic panel 302 for providing a first refresh control signal for a first group pixels of the plurality of pixels 303 of the electrophoretic panel 302 and a second refresh control signal different from the first refresh control signal for a second group pixels of the plurality of pixels 303 of the electrophoretic panel 302 according to the gray levels of the plurality of pixels 303 of the electrophoretic panel 302 when the electrophoretic panel 302 refreshes the frame according to the image signal IS. Please refer to FIG. 3C. FIG. 3C is a diagram illustrating a cross-section of the electrophoretic panel 302. As shown in FIG. 3C, the electrophoretic panel 302 has 16 gray levels G1 to G16. Black particles of the first group pixels corresponding to the gray levels G9 to G16 are near a first side of the electrophoretic panel 302, and black particles of the second group pixels corresponding to the gray levels G1-G8 are near a second side of the electrophoretic panel 302 opposite the first side. But, the present invention is not limited to the electrophoretic panel 302 having 16 gray levels. Please refer to FIG. 3D. FIG. 3D is a diagram illustrating a lookup table 308. As shown in FIG. 3D, the lookup table 308 includes relationships between the plurality of gray levels G1-G16 of the electrophoretic panel 302 and corresponding voltages VG1-VG16 thereof. Therefore, the control signal generation unit 306 can provide gray level control signals for the plurality of pixels 303 according to the lookup table 308 when the electrophoretic panel 302 displays the frame according to the image signal IS.

Please refer to FIG. 3A, FIG. 3C, FIG. 3D, FIG. 4A, FIG. 4B, FIG. 4C, FIG. 4D, and FIG. 4E. FIG. 3A, FIG. 3C, FIG. 3D, FIG. 4A, FIG. 4B, FIG. 4C, and FIG. 4D are diagrams illustrating the control signal generation unit 306 providing a first refresh control signal FRCS for the first group pixels of the plurality of pixels 303 of the electrophoretic panel 302, and a second refresh control signal SRCS different from the first refresh control signal FRCS for the second group pixels of the plurality of pixels 303 of the electrophoretic panel 302 according to gray levels of the plurality of pixels 303 of the electrophoretic panel 302 when the electrophoretic panel 302 refreshes a frame according to an image signal IS according to a second embodiment. FIG. 4E is a diagram illustrating the first refresh control signal FRCS and the second refresh control signal SRCS corresponding to the second embodiment. As shown in FIG. 3B, the plurality of white particles 3032 have negative charges and the plurality of black particles 3034 have positive charges. But, the present invention is not limited to the plurality of white particles 3032 having the negative charges and the plurality of black particles 3034 having the positive charges. That is to say, the plurality of white particles 3032 can also have the positive charges and the plurality of black particles 3034 can also have the negative charges. In addition, because the direction of motion of the plurality of white particles 3032 is opposite the direction of motion of the plurality of black particles 3034 when the control signal generation unit 306 provides the same voltage for the plurality of white particles 3032 and the plurality of black particles 3034, FIG. 4A, FIG. 4B, FIG. 4C, and FIG. 4D only utilize black particles 401, 402 to illustrate the present invention. As shown in FIG. 4A, the black particle 401 having the gray level G12 belongs to the first group pixels of the plurality of pixels 303 of the electrophoretic panel 302, and the black particle 402 having the gray level G5 belongs to the second group pixels of the plurality of pixels 303 of the electrophoretic panel 302. But, the present invention is not limited to the black particle 401 having the gray level G12 and the black particle 402 having the gray level G5. Therefore, the control signal generation unit 306 provides the first refresh control signal FRCS for the first group pixels and the second refresh control signal SRCS for the second group pixels according to the gray levels of the plurality of pixels 303 of the electrophoretic panel 302. As shown in FIG. 4A, during a first interval T1, the first refresh control signal FRCS is at a positive voltage VPOS and the second refresh control signal SRCS is at a negative voltage VNEG, so the black particle 401 moves to a top side of the electrophoretic panel 302, and the black particle 402 moves to a bottom side of the electrophoretic panel 302. As shown in FIG. 4B, during a second interval T2 following the first interval T1, the first refresh control signal FRCS is at the negative voltage VNEG and the second refresh control signal SRCS is at a maintenance voltage VDATA, so the black particle 401 moves to the bottom side of the electrophoretic panel 302, and the black particle 402 is still located at the bottom side of the electrophoretic panel 302. Meanwhile, as shown in FIG. 4C, both the black particle 401 and the black particle 402 are located at the bottom side of the electrophoretic panel 302. Then, the control signal generation unit 306 provides the gray level control signals for the plurality of pixels 303 according to gray levels of the plurality of pixels 303 of the electrophoretic panel 302 when the electrophoretic panel 302 displays a new frame according to the image signal IS, and the lookup table 308. As shown in FIG. 4D, the black particle 401 and the black particle 402 can move to the gray level G7 and the gray level G8 respectively according to the corresponding gray level control signals. That is to say, the black particle 401 moves to the gray level G7 of the electrophoretic panel 302 according to the corresponding gray level control signal (corresponding to the voltage VG7), and the black particle 402 moves to the gray level G8 of the electrophoretic panel 302 according to the corresponding gray level control signal (corresponding to the voltage VG8). In addition, as shown in FIG. 4E, the first interval T1 and the second interval T2 represent time for the electrophoretic panel 302 to refresh the frame, TG7 represents time for the black particle 401 to move from the bottom side of the electrophoretic panel 302 to the gray level G7, and TG8 represents time for the black particle 402 to move from the bottom side of the electrophoretic panel 302 to the gray level G8. Because a distance of motion for the black particle 401 moving from the bottom side of the electrophoretic panel 302 to the gray level G7 is shorter than a distance of motion for the black particle 402 moving from the bottom side of the electrophoretic panel 302 to the gray level G8, TG8 is longer than TG7. In addition, TWAIT represents time for a particle with a shorter moving distance to wait for a particle with a longer moving distance to move to a corresponding gray level. During TWAIT, the control signal generation unit 306 only provides the maintenance voltage VDATA, instead of providing the positive voltage VPOS or the negative voltage VNEG.

Please refer to FIG. 3A, FIG. 3C, FIG. 3D, FIG. 4A, FIG. 5A, FIG. 5B, FIG. 4D, and FIG. 5C. FIG. 3A, FIG. 3C, FIG. 3D, FIG. 4A, FIG. 5A, FIG. 5B, and FIG. 4D are diagrams illustrating the control signal generation unit 306 providing a first refresh control signal FRCS for the first group pixels of the plurality of pixels 303 of the electrophoretic panel 302, and a second refresh control signal SRCS different from the first refresh control signal FRCS for the second group pixels of the plurality of pixels 303 of the electrophoretic panel 302 according to gray levels of the plurality of pixels 303 of the electrophoretic panel 302 when the electrophoretic panel 302 refreshes a frame according to an image signal IS according to a third embodiment. FIG. 5C is a diagram illustrating the first refresh control signal FRCS and the second refresh control signal SRCS corresponding to the third embodiment. As shown in FIG. 4A, the black particle 401 having the gray level G12 belongs to the first group pixels of the plurality of pixels 303 of the electrophoretic panel 302, and the black particle 402 having the gray level G5 belongs to the second group pixels of the plurality of pixels 303 of the electrophoretic panel 302. Therefore, the control signal generation unit 306 provides the first refresh control signal FRCS for the first group pixels and the second refresh control signal SRCS for the second group pixels according to the gray levels of the plurality of pixels 303 of the electrophoretic panel 302. As shown in FIG. 4A, during a first interval T1, the first refresh control signal FRCS is at the positive voltage VPOS and the second refresh control signal SRCS is at the negative voltage VNEG, so the black particle 401 moves to the top side of the electrophoretic panel 302, and the black particle 402 moves to the bottom side of the electrophoretic panel 302. As shown in FIG. 5A, during a second interval T2 following the first interval T1, the first refresh control signal FRCS is at the maintenance voltage VDATA and the second refresh control signal SRCS is at the positive voltage VPOS, so the black particle 401 is still located at the top side of the electrophoretic panel 302, and the black particle 402 moves to the top side of the electrophoretic panel 302. Meanwhile, as shown in FIG. 5B, both the black particle 401 and the black particle 402 are located at the top side of the electrophoretic panel 302. Then, the control signal generation unit 306 provides gray level control signals for the plurality of pixels 303 according to gray levels of the plurality of pixels 303 of the electrophoretic panel 302 when the electrophoretic panel 302 displays anew frame according to the image signal IS, and the lookup table 308. Therefore, as shown in FIG. 4D, the black particle 401 and the black particle 402 can move to the gray level G7 and the gray level G8 respectively according to the corresponding gray level control signals. In addition, as shown in FIG. 5C, the first interval T1 and the second interval T2 represent time for the electrophoretic panel 302 to refresh the frame, TG7 represents time for the black particle 401 to move from the top side of the electrophoretic panel 302 to the gray level G7, and TG8 represents time for the black particle 402 to move from the top side of the electrophoretic panel 302 to the gray level G8. Because a distance of motion for the black particle 401 moving from the top side of the electrophoretic panel 302 to the gray level G7 is longer than a distance of motion for the black particle 402 moving from the top side of the electrophoretic panel 302 to the gray level G8, TG7 is longer than TG8. In addition, TWAIT represents time for a particle with a shorter distance of motion to wait for a particle with a longer distance of motion to move to a corresponding gray level. During TWAIT, the control signal generation unit 306 only provides the maintenance voltage VDATA, instead of providing the positive voltage VPOS or the negative voltage VNEG.

Please refer to FIG. 3A, FIG. 3C, FIG. 3D, FIG. 4A, FIG. 6A, FIG. 6B, FIG. 5B, FIG. 4D, and FIG. 6C. FIG. 3A, FIG. 3C, FIG. 3D, FIG. 4A, FIG. 6A, FIG. 6B, FIG. 5B, FIG. 4D are diagrams illustrating the control signal generation unit 306 providing a first refresh control signal FRCS for the first group pixels of the plurality of pixels 303 of the electrophoretic panel 302, and a second refresh control signal SRCS different from the first refresh control signal FRCS for the second group pixels of the plurality of pixels 303 of the electrophoretic panel 302 according to gray levels of the plurality of pixels 303 of the electrophoretic panel 302 when the electrophoretic panel 302 refreshes a frame according to an image signal IS according to a fourth embodiment. FIG. 6C is a diagram illustrating the first refresh control signal FRCS and the second refresh control signal SRCS corresponding to the fourth embodiment. As shown in FIG. 4A, the black particle 401 having the gray level G12 belongs to the first group pixels of the plurality of pixels 303 of the electrophoretic panel 302, and the black particle 402 having the gray level G5 belongs to the second group pixels of the plurality of pixels 303 of the electrophoretic panel 302. Therefore, the control signal generation unit 306 provides the first refresh control signal FRCS for the first group pixels and the second refresh control signal SRCS for the second group pixels according to the gray levels of the plurality of pixels 303 of the electrophoretic panel 302. As shown in FIG. 4A, during a first interval T1, the first refresh control signal FRCS is at the positive voltage VPOS and the second refresh control signal SRCS is at the negative voltage VNEG, so the black particle 401 moves to the top side of the electrophoretic panel 302, and the black particle 402 moves to the bottom side of the electrophoretic panel 302. As shown in FIG. 6A, during a second interval T2 following the first interval T1, the first refresh control signal FRCS is at the negative voltage VNEG and the second refresh control signal SRCS is at the positive voltage VPOS, so the black particle 401 moves to the bottom side of the electrophoretic panel 302, and the black particle 402 moves to the top side of the electrophoretic panel 302. As shown in FIG. 6B, during a third interval T3 following the second interval T2, the first refresh control signal FRCS is at the positive voltage VPOS and the second refresh control signal SRCS is at the maintenance voltage VDATA, so the black particle 401 moves to the top side of the electrophoretic panel 302, and the black particle 402 is still located at the top side of the electrophoretic panel 302. Meanwhile, as shown in FIG. 5B, both the black particle 401 and the black particle 402 are located at the top side of the electrophoretic panel 302. Then, the control signal generation unit 306 provides gray level control signals for the plurality of pixels 303 according to gray levels of the plurality of pixels 303 of the electrophoretic panel 302 when the electrophoretic panel 302 displays anew frame according to the image signal IS, and the lookup table 308. Therefore, as shown in FIG. 4D, the black particle 401 and the black particle 402 can move to the gray level G7 and the gray level G8 respectively according to the corresponding gray level control signals. In addition, as shown in FIG. 6C, the first interval T1, the second interval T2, and the third interval T3 represent time for the electrophoretic panel 302 to refresh the frame, TG7 represents time for the black particle 401 to move from the top side of the electrophoretic panel 302 to the gray level G7, and TG8 represents time for the black particle 402 to move from the top side of the electrophoretic panel 302 to the gray level G8. Because a distance of motion for the black particle 401 to move from the top side of the electrophoretic panel 302 to the gray level G7 is longer than a distance of motion for the black particle 402 to move from the bottom side of the electrophoretic panel 302 to the gray level G8, TG7 is longer than TG8. In addition, TWAIT represents time for a particle with a shorter distance of motion to wait for a particle with a longer distance of motion to move to a corresponding gray level. During TWAIT, the control signal generation unit 306 only provides the maintenance voltage VDATA, instead of providing the positive voltage VPOS or the negative voltage VNEG.

Please refer to FIG. 3A, FIG. 3C, FIG. 3D, FIG. 4A, FIG. 6A, FIG. 7A, FIG. 4C, FIG. 4D, and FIG. 7B. FIG. 3A, FIG. 3C, FIG. 3D, FIG. 4A, FIG. 6A, FIG. 7A, FIG. 4C, and FIG. 4D are diagrams illustrating the control signal generation unit 306 providing a first refresh control signal FRCS for the first group pixels of the plurality of pixels 303 of the electrophoretic panel 302, and a second refresh control signal SRCS different from the first refresh control signal FRCS for the second group pixels of the plurality of pixels 303 of the electrophoretic panel 302 according to gray levels of the plurality of pixels 303 of the electrophoretic panel 302 when the electrophoretic panel 302 refreshes a frame according to an image signal IS according to a fifth embodiment. FIG. 7B is a diagram illustrating the first refresh control signal FRCS and the second refresh control signal SRCS corresponding to the fifth embodiment. As shown in FIG. 4A, the black particle 401 having the gray level G12 belongs to the first group pixels of the plurality of pixels 303 of the electrophoretic panel 302, and the black particle 402 having the gray level G5 belongs to the second group pixels of the plurality of pixels 303 of the electrophoretic panel 302. Therefore, the control signal generation unit 306 provides the first refresh control signal FRCS for the first group pixels and the second refresh control signal SRCS for the second group pixels according to the gray levels of the plurality of pixels 303 of the electrophoretic panel 302. As shown in FIG. 4A, during a first interval T1, the first refresh control signal FRCS is at the positive voltage VPOS and the second refresh control signal SRCS is at the negative voltage VNEG, so the black particle 401 moves to the top side of the electrophoretic panel 302, and the black particle 402 moves to the bottom side of the electrophoretic panel 302. As shown in FIG. 6A, during a second interval T2 following the first interval T1, the first refresh control signal FRCS is at the negative voltage VNEG and the second refresh control signal SRCS is at the positive voltage VPOS, so the black particle 401 moves to the bottom side of the electrophoretic panel 302, and the black particle 402 moves to the top side of the electrophoretic panel 302. As shown in FIG. 7A, during a third interval T3 following the second interval T2, the first refresh control signal FRCS is at the maintenance voltage VDATA and the second refresh control signal SRCS is at the negative voltage VNEG, so the black particle 401 is still located at the bottom side of the electrophoretic panel 302, and the black particle 402 moves to the bottom side of the electrophoretic panel 302. Meanwhile, as shown in FIG. 4C, both the black particle 401 and the black particle 402 are located at the bottom side of the electrophoretic panel 302. Then, the control signal generation unit 306 provides gray level control signals for the plurality of pixels 303 according to gray levels of the plurality of pixels 303 of the electrophoretic panel 302 when the electrophoretic panel 302 displays anew frame according to the image signal IS, and the lookup table 308. Therefore, as shown in FIG. 4D, the black particle 401 and the black particle 402 can move to the gray level G7 and the gray level G8 respectively according to the corresponding gray level control signals. In addition, as shown in FIG. 7B, the first interval T1, the second interval T2, and the third interval T3 represent time for the electrophoretic panel 302 to refresh the frame, TG7 represents time for the black particle 401 to move from the bottom side of the electrophoretic panel 302 to the gray level G7, and TG8 represents time for the black particle 402 to move from the bottom side of the electrophoretic panel 302 to the gray level G8. Because a distance of motion for the black particle 401 to move from the bottom side of the electrophoretic panel 302 to the gray level G7 is shorter than a distance of motion for the black particle 402 to move from the bottom side of the electrophoretic panel 302 to the gray level G8, TG8 is longer than TG7. In addition, TWAIT represents time for a particle with a shorter distance of motion to wait for a particle with a longer distance of motion to move to a corresponding gray level. During TWAIT, the control signal generation unit 306 only provides the maintenance voltage VDATA, instead of providing the positive voltage VPOS or the negative voltage VNEG.

Please refer to FIG. 3A, FIG. 3C, FIG. 3D, FIG. 4A, FIG. 6A, FIG. 8A, FIG. 4D, and FIG. 8B. FIG. 3A, FIG. 3C, FIG. 3D, FIG. 4A, FIG. 6A, FIG. 8A, and FIG. 4D are diagrams illustrating the control signal generation unit 306 providing a first refresh control signal FRCS for the first group pixels of the plurality of pixels 303 of the electrophoretic panel 302, and a second refresh control signal SRCS different from the first refresh control signal FRCS for the second group pixels of the plurality of pixels 303 of the electrophoretic panel 302 according to gray levels of the plurality of pixels 303 of the electrophoretic panel 302 when the electrophoretic panel 302 refreshes a frame according to an image signal IS according to a sixth embodiment. FIG. 8B is a diagram illustrating the first refresh control signal FRCS and the second refresh control signal SRCS corresponding to the sixth embodiment. As shown in FIG. 4A, the black particle 401 having the gray level G12 belongs to the first group pixels of the plurality of pixels 303 of the electrophoretic panel 302, and the black particle 402 having the gray level G5 belongs to the second group pixels of the plurality of pixels 303 of the electrophoretic panel 302. Therefore, the control signal generation unit 306 provides the first refresh control signal FRCS for the first group pixels and the second refresh control signal SRCS for the second group pixels according to the gray levels of the plurality of pixels 303 of the electrophoretic panel 302. As shown in FIG. 4A, during a first interval T1, the first refresh control signal FRCS is at the positive voltage VPOS and the second refresh control signal SRCS is at the negative voltage VNEG, so the black particle 401 moves to the top side of the electrophoretic panel 302, and the black particle 402 moves to the bottom side of the electrophoretic panel 302. As shown in FIG. 6A, during a second interval T2 following the first interval T1, the first refresh control signal FRCS is at the negative voltage VNEG and the second refresh control signal SRCS is at the positive voltage VPOS, so the black particle 401 moves to the bottom side of the electrophoretic panel 302, and the black particle 402 moves to the top side of the electrophoretic panel 302. Meanwhile, as shown in FIG. 8A, the black particle 401 is located at the bottom side of the electrophoretic panel 302 and the black particle 402 is located at the top side of the electrophoretic panel 302. Then, the control signal generation unit 306 provides gray level control signals for the plurality of pixels 303 according to gray levels of the plurality of pixels 303 of the electrophoretic panel 302 when the electrophoretic panel 302 displays a new frame according to the image signal IS, and the lookup table 308. Therefore, as shown in FIG. 4D, the black particle 401 and the black particle 402 can move to the gray level G7 and the gray level G8 respectively according to the corresponding gray level control signals. In addition, as shown in FIG. 8B, the first interval T1 and the second interval T2 represent time for the electrophoretic panel 302 to refresh the frame, TG7 represents time for the black particle 401 to move from the bottom side of the electrophoretic panel 302 to the gray level G7, and TG8 represents time for the black particle 402 to move from the top side of the electrophoretic panel 302 to the gray level G8. Because a distance of motion for the black particle 401 to move from the bottom side of the electrophoretic panel 302 to the gray level G7 is shorter than a distance of motion for the black particle 402 to move from the top side of the electrophoretic panel 302 to the gray level G8, TG8 is longer than TG7. In addition, TWAIT represents time for a particle with a shorter distance of motion to wait for a particle with a longer distance of motion to move to a corresponding gray level. During TWAIT, the control signal generation unit 306 only provides the maintenance voltage VDATA, instead of providing the positive voltage VPOS or the negative voltage VNEG.

Please refer to FIG. 9. FIG. 9 is a flowchart illustrating a frame refresh method capable of reducing ghost shadows according to a seventh embodiment. The method in FIG. 9 is illustrated using the electrophoretic display 300 in FIG. 3A. Detailed steps are as follows:

Step 900: Start.

Step 902: The pixel gray level recording unit 304 records gray levels of the plurality of pixels 303 of the electrophoretic panel 302 when the electrophoretic panel 302 displays a frame according to an image signal IS.

Step 904: During a first interval T1, the control signal generation unit 306 provides the positive voltage VPOS for the first group pixels of the plurality of pixels 303, and the negative voltage VNEG for the second group pixels of the plurality of pixels 303 according to the gray levels of the plurality of pixels 303.

Step 906: During a second interval T2, the control signal generation unit 306 provides the negative voltage VNEG for the first group pixels of the plurality of pixels 303, and the maintenance voltage VDATA for the second group pixels of the plurality of pixels 303 according to the gray levels of the plurality of pixels 303.

Step 908: The control signal generation unit 306 provides corresponding gray level control signals for the plurality of pixels 303 according to gray levels of the plurality of pixels 303 of the electrophoretic panel 302 when the electrophoretic panel 302 displays a new frame according to the image signal IS, and the lookup table 308 after the electrophoretic panel 302 refreshes the frame.

Step 910: The control signal generation unit 306 adjusts the gray levels of the plurality of pixels 303 of the electrophoretic panel 302 to correspond to the new frame according to the corresponding gray level control signals.

Step 912: End.

Please refer to FIG. 3A, FIG. 3C, FIG. 3D, FIG. 4A, FIG. 4B, FIG. 4C, and FIG. 4D. In Step 904 (as shown in FIG. 4A), the black particle 401 having the gray level G12 belongs to the first group pixels of the plurality of pixels 303 of the electrophoretic panel 302, and the black particle 402 having the gray level G5 belongs to the second group pixels of the plurality of pixels 303 of the electrophoretic panel 302. Therefore, during the first interval T1, the control signal generation unit 306 provides the positive voltage VPOS for the first group pixels of the plurality of pixels 303, and the negative voltage VNEG for the second group pixels of the plurality of pixels 303. Then, the black particle 401 moves to the top side of the electrophoretic panel 302 according to the positive voltage VPOS, and the black particle 402 moves to the bottom side of the electrophoretic panel 302 according to the negative voltage VNEG. In Step 906 (as shown in FIG. 4B), during the second interval T2, because the control signal generation unit 306 provides the negative voltage VNEG for the first group pixels of the plurality of pixels 303, and the maintenance voltage VDATA for the second group pixels of the plurality of pixels 303, the black particle 401 moves to the bottom side of the electrophoretic panel 302 according to the negative voltage VNEG, and the black particle 402 is still located at the bottom side of the electrophoretic panel 302 according to the maintenance voltage VDATA. In Step 908 (as shown in FIG. 4C), both the black particle 401 and the black particle 402 are located at the bottom side of the electrophoretic panel 302. Then, the control signal generation unit 306 provides the corresponding gray level control signals for the plurality of pixels 303 according to the gray levels of the plurality of pixels 303 of the electrophoretic panel 302 when the electrophoretic panel 302 displays the new frame according to the image signal IS, and the lookup table 308. In Step 910, the control signal generation unit 306 adjusts the gray levels of the plurality of pixels 303 of the electrophoretic panel 302 to correspond to the new frame according to the corresponding gray level control signals. Therefore, as shown in FIG. 4D, the black particle 401 and the black particle 402 can move to the gray level G7 and the gray level G8 respectively according to the corresponding gray level control signals.

Please refer to FIG. 10. FIG. 10 is a flowchart illustrating a frame refresh method capable of reducing ghost shadows according to an eighth embodiment. The method in FIG. 10 is illustrated using the electrophoretic display 300 in FIG. 3A. Detailed steps are as follows:

Step 1000: Start.

Step 1002: The pixel gray level recording unit 304 records gray levels of the plurality of pixels 303 of the electrophoretic panel 302 when the electrophoretic panel 302 displays a frame according to an image signal IS.

Step 1004: During a first interval T1, the control signal generation unit 306 provides the positive voltage VPOS for the first group pixels of the plurality of pixels 303, and the negative voltage VNEG for the second group pixels of the plurality of pixels 303 according to the gray levels of the plurality of pixels 303.

Step 1006: During a second interval T2, the control signal generation unit 306 provides the maintenance voltage VDATA for the first group pixels of the plurality of pixels 303, and the positive voltage VPOS for the second group pixels of the plurality of pixels 303 according to the gray levels of the plurality of pixels 303.

Step 1008: The control signal generation unit 306 provides corresponding gray level control signals for the plurality of pixels 303 according to gray levels of the plurality of pixels 303 of the electrophoretic panel 302 when the electrophoretic panel 302 displays a new frame according to the image signal IS, and the lookup table 308 after the electrophoretic panel 302 refreshes the frame.

Step 1010: The control signal generation unit 306 adjusts the gray levels of the plurality of pixels 303 of the electrophoretic panel 302 to correspond to the new frame according to the corresponding gray level control signals.

Step 1012: End.

Please refer to FIG. 5A and FIG. 5B. A difference between the eighth embodiment and the seventh embodiment is that in Step 1006 (as shown in FIG. 5A), during the second interval T2, because the control signal generation unit 306 provides the maintenance voltage VDATA for the first group pixels of the plurality of pixels 303, and the positive voltage VPOS for the second group pixels of the plurality of pixels 303, the black particle 401 is still located at the top side of the electrophoretic panel 302 according to the maintenance voltage VDATA, and the black particle 402 moves to the top side of the electrophoretic panel 302 according to the positive voltage VPOS. In Step 1008 (as shown in FIG. 5B), both the black particle 401 and the black particle 402 are located at the top side of the electrophoretic panel 302. Then, the control signal generation unit 306 provides the corresponding gray level control signals for the plurality of pixels 303 according to the gray levels of the plurality of pixels 303 of the electrophoretic panel 302 when the electrophoretic panel 302 displays the new frame according to the image signal IS, and the lookup table 308. Further, subsequent operational principles of the eighth embodiment are the same as those of the seventh embodiment, so further description thereof is omitted for simplicity.

Please refer to FIG. 11. FIG. 11 is a flowchart illustrating a frame refresh method capable of reducing ghost shadows according to a ninth embodiment. The method in FIG. 11 is illustrated using the electrophoretic display 300 in FIG. 3A. Detailed steps are as follows:

Step 1100: Start.

Step 1102: The pixel gray level recording unit 304 records gray levels of the plurality of pixels 303 of the electrophoretic panel 302 when the electrophoretic panel 302 displays a frame according to an image signal IS.

Step 1104: During a first interval T1, the control signal generation unit 306 provides the positive voltage VPOS for the first group pixels of the plurality of pixels 303, and the negative voltage VNEG for the second group pixels of the plurality of pixels 303 according to the gray levels of the plurality of pixels 303.

Step 1106: During a second interval T2, the control signal generation unit 306 provides the negative voltage VNEG for the first group pixels of the plurality of pixels 303, and the positive voltage VPOS for the second group pixels of the plurality of pixels 303 according to the gray levels of the plurality of pixels 303.

Step 1108: At a third interval T3, the control signal generation unit 306 provides the positive voltage VPOS for the first group pixels of the plurality of pixels 303, and the maintenance voltage VDATA for the second group pixels of the plurality of pixels 303 according to the gray levels of the plurality of pixels 303.

Step 1110: The control signal generation unit 306 provides corresponding gray level control signals for the plurality of pixels 303 according to gray levels of the plurality of pixels 303 of the electrophoretic panel 302 when the electrophoretic panel 302 displays a new frame according to the image signal IS, and the lookup table 308 after the electrophoretic panel 302 refreshes the frame.

Step 1112: The control signal generation unit 306 adjusts the gray levels of the plurality of pixels 303 of the electrophoretic panel 302 to correspond to the new frame according to the corresponding gray level control signals.

Step 1114: End.

Please refer to FIG. 6A and FIG. 6B. A difference between the ninth embodiment and the seventh embodiment is that in Step 1106 (as shown in FIG. 6A), during the second interval T2, because the control signal generation unit 306 provides the negative voltage VNEG for the first group pixels of the plurality of pixels 303, and the positive voltage VPOS for the second group pixels of the plurality of pixels 303, the black particle 401 moves to the bottom side of the electrophoretic panel 302 according to negative voltage VNEG, and the black particle 402 moves to the top side of the electrophoretic panel 302 according to the positive voltage VPOS; in Step 1108 (as shown in FIG. 6B), at the third interval T3, because the control signal generation unit 306 provides the positive voltage VPOS for the first group pixels of the plurality of pixels 303, and the maintenance voltage VDATA for the second group pixels of the plurality of pixels 303, the black particle 401 moves to the top side of the electrophoretic panel 302 according to the positive voltage VPOS, and the black particle 402 is still located at the top side of the electrophoretic panel 302 according to the maintenance voltage VDATA. Further, subsequent operational principles of the ninth embodiment are the same as those of the seventh embodiment, so further description thereof is omitted for simplicity.

Please refer to FIG. 12. FIG. 12 is a flowchart illustrating a frame refresh method capable of reducing ghost shadows according to a tenth embodiment. The method in FIG. 12 is illustrated using the electrophoretic display 300 in FIG. 3A. Detailed steps are as follows:

Step 1200: Start.

Step 1202: The pixel gray level recording unit 304 records gray levels of the plurality of pixels 303 of the electrophoretic panel 302 when the electrophoretic panel 302 displays a frame according to an image signal IS.

Step 1204: During a first interval T1, the control signal generation unit 306 provides the positive voltage VPOS for the first group pixels of the plurality of pixels 303, and the negative voltage VNEG for the second group pixels of the plurality of pixels 303 according to the gray levels of the plurality of pixels 303.

Step 1206: During a second interval T2, the control signal generation unit 306 provides the negative voltage VNEG for the first group pixels of the plurality of pixels 303, and the positive voltage VPOS for the second group pixels of the plurality of pixels 303 according to the gray levels of the plurality of pixels 303.

Step 1208: At a third interval T3, the control signal generation unit 306 provides the maintenance voltage VDATA for the first group pixels of the plurality of pixels 303, and the negative voltage VNEG for the second group pixels of the plurality of pixels 303 according to the gray levels of the plurality of pixels 303.

Step 1210: The control signal generation unit 306 provides corresponding gray level control signals for the plurality of pixels 303 according to gray levels of the plurality of pixels 303 of the electrophoretic panel 302 when the electrophoretic panel 302 displays a new frame according to the image signal IS, and the lookup table 308 after the electrophoretic panel 302 refreshes the frame.

Step 1212: The control signal generation unit 306 adjusts the gray levels of the plurality of pixels 303 of the electrophoretic panel 302 to correspond to the new frame according to the corresponding gray level control signals.

Step 1214: End.

Please refer to FIG. 7A. A difference between the tenth embodiment and the ninth embodiment is that in Step 1208 (as shown in FIG. 7A), at the third interval T3, because the control signal generation unit 306 provides the maintenance voltage VDATA for the first group pixels of the plurality of pixels 303, and the negative voltage VNEG for the second group pixels of the plurality of pixels 303, the black particle 401 is still located at the bottom side of the electrophoretic panel 302 according to the maintenance voltage VDATA, and the black particle 402 moves to the bottom side of the electrophoretic panel 302 according to the negative voltage VNEG. Further, subsequent operational principles of the tenth embodiment are the same as those of the ninth embodiment, so further description thereof is omitted for simplicity.

Please refer to FIG. 13. FIG. 13 is a flowchart illustrating a frame refresh method capable of reducing ghost shadows according to an eleventh embodiment. The method in FIG. 13 is illustrated using the electrophoretic display 300 in FIG. 3A. Detailed steps are as follows:

Step 1300: Start.

Step 1302: The pixel gray level recording unit 304 records gray levels of the plurality of pixels 303 of the electrophoretic panel 302 when the electrophoretic panel 302 displays a frame according to an image signal IS.

Step 1304: During a first interval T1, the control signal generation unit 306 provides the positive voltage VPOS for the first group pixels of the plurality of pixels 303, and the negative voltage VNEG for the second group pixels of the plurality of pixels 303 according to the gray levels of the plurality of pixels 303.

Step 1306: During a second interval T2, the control signal generation unit 306 provides the negative voltage VNEG for the first group pixels of the plurality of pixels 303, and the positive voltage VPOS for the second group pixels of the plurality of pixels 303 according to the gray levels of the plurality of pixels 303.

Step 1308: The control signal generation unit 306 provides corresponding gray level control signals for the plurality of pixels 303 according to gray levels of the plurality of pixels 303 of the electrophoretic panel 302 when the electrophoretic panel 302 displays a new frame according to the image signal IS, and the lookup table 308 after the electrophoretic panel 302 refreshes the frame.

Step 1310: The control signal generation unit 306 adjusts the gray levels of the plurality of pixels 303 of the electrophoretic panel 302 to correspond to the new frame according to the corresponding gray level control signals.

Step 1312: End.

Please refer to FIG. 6A and FIG. 8A. A difference between the eleventh embodiment and the seventh embodiment is that in Step 1306 (as shown in FIG. 6A), during the second interval T2, the control signal generation unit 306 provides the negative voltage VNEG for the first group pixels of the plurality of pixels 303, and the positive voltage VPOS for the second group pixels of the plurality of pixels 303, the black particle 401 moves to the bottom side of the electrophoretic panel 302 according to the negative voltage VNEG, and the black particle 402 moves to the top side of the electrophoretic panel 302 according to the positive voltage VPOS. Meanwhile, as shown in FIG. 8A, the black particle 401 is located at the bottom side of the electrophoretic panel 302, and the black particle 402 is located at the top side of the electrophoretic panel 302. Further, subsequent operational principles of the eleventh embodiment are the same as those of the seventh embodiment, so further description thereof is omitted for simplicity.

To sum up, advantages of the electrophoretic display capable of reducing the ghost shadows and the frame refresh method thereof are that particles (a plurality of black particles and a plurality of white particles) of each pixel of the electrophoretic panel are disturbed according to a gray level of each pixel as the electrophoretic panel refreshes a frame. Because paths of motion of particles included by the plurality of pixels of the electrophoretic panel do not all first move upward and then move downward to the bottom of the electrophoretic display, or first move downward and then move upward to the top of the electrophoretic display, the present invention can improve strong flicker of the electrophoretic panel while the electrophoretic panel refreshes the frame. In addition, the present invention can determine paths of motion of particles of each pixel according to a gray level of the pixel, so the present invention can not only reduce distances of motion of particles of each pixel, but also does not provide an additional voltage for a particle with a shorter distance of motion when the particle with the shorter distance of motion waits for a particle with a longer distance of motion to move to a corresponding gray level. Thus, compared to the prior art, the present invention can reduce time and power consumption for the electrophoretic panel to refresh the frame.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electrophoretic display capable of reducing ghost shadows, the electrophoretic display comprising:
an electrophoretic panel comprising a plurality of pixels;
a pixel gray level recording unit for recording gray levels of the plurality of pixels when the electrophoretic panel displays a frame according to an image signal; and
a control signal generation unit coupled to the pixel gray level recording unit and the plurality of pixels for providing a first refresh control signal for a first group pixels of the plurality of pixels and a second refresh control signal different from the first refresh control signal for a second group pixels of the plurality of pixels according to the gray levels of the plurality of pixels when the electrophoretic panel refreshes the frame according to the image signal.

2. The electrophoretic display of claim 1, wherein the control signal generation unit provides gray level control signals for the plurality of pixels according to gray levels of the plurality of pixels when the electrophoretic panel displays a new frame according to the image signal and a lookup table after the electrophoretic panel refreshes the frame.

3. The electrophoretic display of claim 1, wherein the lookup table comprises relationships between a plurality of gray levels of the electrophoretic panel and corresponding voltages thereof.

4. The electrophoretic display of claim 1, wherein each pixel of the plurality of pixels comprises a plurality of white particles and a plurality of black particles.

5. The electrophoretic display of claim 4, wherein black particles of the first group pixels are near a first side of the electrophoretic panel, and black particles of the second group pixels are near a second side of the electrophoretic panel opposite the first side.

6. A frame refresh method capable of reducing ghost shadows, the frame refresh method comprising:
recording gray levels of a plurality of pixels when an electrophoretic panel displays a frame according to an image signal;
providing a first refresh control signal for a first group pixels of the plurality of pixels and a second refresh control signal different from the first refresh control signal for a second group pixels of the plurality of pixels according to the gray levels of the plurality of pixels when the electrophoretic panel refreshes the frame according to the image signal; and
providing gray level control signals for the plurality of pixels according to gray levels of the plurality of pixels when the electrophoretic panel displays a new frame according to the image signal, and a lookup table to adjust the gray levels of the plurality of pixels to correspond to the new frame after the electrophoretic panel refreshes the frame.

7. The frame refresh method of claim 6, wherein the first refresh control signal is at a positive voltage during a first interval, and the second refresh control signal is at a negative voltage during the first interval.

8. The frame refresh method of claim 7, wherein the first refresh control signal is at the negative voltage during a second interval following the first interval, and the second refresh control signal is at a maintenance voltage during the second interval.

9. The frame refresh method of claim 7, wherein the first refresh control signal is at a maintenance voltage during a second interval following the first interval, and the second refresh control signal is at the positive voltage during the second interval.

10. The frame refresh method of claim 7, wherein the first refresh control signal is at the negative voltage during a second interval following the first interval, and the second refresh control signal is at the positive voltage during the second interval.

11. The frame refresh method of claim 10, wherein the first refresh control signal is at the positive voltage during a third interval following the second interval, and the second refresh control signal is at a maintenance voltage during the third interval.

12. The frame refresh method of claim 10, wherein the first refresh control signal is at a maintenance voltage during a third interval following the second interval, and the second refresh control signal is at the negative voltage during the third interval.
